(19) United States
(12) Patent Application Publication
(10) Pub. No.: US 2007/0218422 A1
(43) Pub. Date: Sep. 20, 2007

(54) Adjustable cheek retractor with saliva extracting tongue guard

(76) Inventor: Richard J. Ehrenfeld, Hobart, IN (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/709,978

(22) Filed: Feb. 23, 2007

Related U.S. Application Data
(60) Provisional application No. 60/743,354, filed on Feb. 24, 2006.

(51) Int. Cl. A61C 5/00; A61C 17/06

(52) U.S. Cl. 433/140; 433/93

(57) ABSTRACT

An adjustable cheek retractor with saliva extracting tongue guard is designed with minimal parts to hold back cheeks, facilitate the removal of saliva, protect a patient's tongue and give a dental professional an unrestricted view of the patient's mouth, all without the need of an assistant to perform these duties. The tongue guard has various attachment slots allowing for adjustability in a forward and rearward direction in order to optimize fit and comfort for the patient. The cheek retractor and tongue guard come in various sizes, again to optimize fit and comfort. The tongue guard contains various holders to secure perforated tubing typically attached to a vacuum source in order to extract saliva from the patient's mouth. The tongue guard also contains a blind stop which is used to secure and plug the end of the vacuum tubing, allowing the perforations to be the points at which saliva is extracted.

### RELATED APPLICATIONS

This application claims priority benefit of U.S. Provisional Patent Application No. 60/743,354, filed Feb. 24, 2006, the entirety of which is hereby incorporated by reference.

### BACKGROUND

1. Field of the Disclosure

This disclosure relates to an adjustable cheek retractor with saliva extracting tongue guard comprised of a minimal number of parts.

2. Description of the Related Art

Dental professionals currently have access to various devices which retract cheeks, protect a patient's tongue, and extract saliva from a patient's mouth. Cheek retractors are used to hold the patient's mouth wide open so that the dental professional can have easy access to the teeth. These retractors typically come in at least three sizes to conform to the patient's mouth size. Saliva extractors are used to remove saliva from the patient's mouth in order to make working within the mouth more comfortable and less sloppy for all involved. Saliva extractors typically are comprised of thin perforated tubing which is placed in the patient's mouth either alone or attached to another device. A vacuum source is attached to the tubing in order to draw saliva from the work area. Tongue guards are used to protect the tongue from being accidentally injured by the dental professional. Some of these devices are combined together comprising as many as nine parts in order to retract a patient's cheeks, protect a patient's tongue, and extract saliva from the patient's mouth concurrently.

### SUMMARY

This disclosure, comprising as few as three parts, a cheek retractor, a tongue guard and a perforated tube, can accomplish these same tasks for a dental professional. Fewer parts can reduce the possibility of choking for the patient. In a middle section, the cheek retractor of this disclosure contains an angled tab, unique to the industry, which is used to secure the retractor with the tongue guard. The tab fits into one of a plurality of slots, also unique to the industry, formed on a top surface of the tongue guard. These slots allow for forward and backward adjustability in the relative positioning of the cheek retractor and tongue guard. The position of the slot chosen will depend on what is most comfortable for the patient. The tongue guard also contains various holders to secure the perforated tubing that acts as a saliva extractor. The tongue guard also contains a blind stop in order to secure and plug the end of the vacuum tubing. The tongue guard and cheek retractor come in a range of sizes so as to maximize the fit comfort for the patient. The material comprising the cheek retractor and the tongue guard can be sterilized in an autoclave for safe reuse or can be disposable.

An adjustable cheek retractor system comprises a cheek retractor, a tongue guard, and a saliva extractor, which mate together to form a sturdy multi-functional device that a lone dental professional can install and remove. The cheek retractor is used to spread apart the lips and mouth of a patient and hold them in that position, away from the teeth and gums, which are typically areas accessed by a dental professional. The cheek retractor comprises two semi-circular ends, each having a curved surface which is used to rest against and grip the natural curve of the left and right sides of a wide-open mouth. Each end of the cheek retractor is connected together via a curved piece, which gives the retractor the ability to spring open in a lateral manner when it is forced to a closed state, thereby adjusting itself to a maximum wide-open position for any given size mouth. These retractors typically come in at least three sizes or overall widths, to be chosen initially by visual estimation of the dental professional, in order to fit into the small-sized mouth of a child, or the medium or large-sized mouth of an adult. Halfway between each retractor end, along the curved piece that joins them together, there lies an angled tab, the tip of which points away from the mouth of the patient when the retractor is installed. This angled tab locks the cheek retractor into the adjusting slots on top of the tongue guard.

The tongue guard contains various slots on its flat top and these slots receive the angled tab of the cheek retractor, as adjusted by the dental professional for the comfort of the patient. The flat top of the tongue guard has sidewalls and a front wall that drop down thus providing an area in which the tongue can be protected from being accidentally struck and injured by a dental implement. The tongue guards come in at least three sizes, in order to give the dental professional flexibility in choosing an appropriate size for the patient's comfort. The tongue guard contains various round holders molded along the bottom edge of the guard, in order to receive and secure perforated tubing used for extracting saliva from the mouth of the patient. A length of perforated tubing is threaded through these holders, which have the same internal circumference as the external circumference of the tubing, thereby facilitating a press fit and thus securing the tubing in place. For example, the threading may begin at the first open holder and continue to each adjacent open holder curving around the front of the bottom edge of the guard and wrapping back around until the end of the tubing is plugged into a blind stop molded into the bottom edge of the guard. This blind stop receives the end of the tubing, secures it, and seals it. The other end of the tubing is plugged into a vacuum source that is typically available in the immediate area. When a vacuum source is applied to the tubing, saliva that is near any of the perforations in the tubing will be drawn into the tubing and carried away from the mouth of the patient.

### BRIEF DESCRIPTION OF THE DRAWINGS

FIG. 1 is a perspective view of one embodiment of an adjustable cheek retractor with saliva extracting tongue guard positioned as it would be before insertion into a dental patient's mouth, in accordance with an aspect of the disclosure.

FIG. 2A is a top view thereof.

FIG. 2B is a bottom view thereof.

FIG. 3A is a close-up right front view of one embodiment of the tongue guard portion of the disclosure;

FIG. 3B is a close-up left rear view of one embodiment of the tongue guard portion of the disclosure;

FIG. 4 is a front view of one embodiment of the adjustable cheek retractor with saliva extracting tongue guard disclosure;

### DETAILED DESCRIPTION

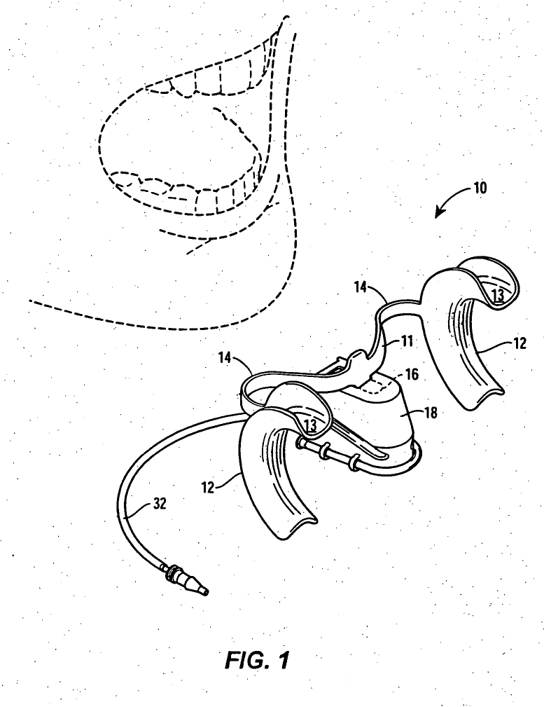

Having reference to the drawings, where like reference numbers comprise like elements, there is shown in FIG. 1 an adjustable cheek retractor with saliva extracting tongue guard, generally denoted by reference number 10. This adjustable cheek retractor with saliva extracting tongue guard 10 comprises a cheek retractor 11 which is attachable to a tongue guard 18, having a length of perforated tubing 32 disposed thereon. The cheek retractor 11 portion of this disclosure may be standard cheek retractor, such as a “Spandezz” cheek retractor manufactured by the Glenroe Technologies Company modified as discussed hereinafter.

On each end of the cheek retractor 11, there lies a lip grip 12 including an arcuate race 13. When the adjustable cheek retractor with saliva extracting tongue guard 10 is installed into a patient's mouth, each lip grip 12 is initially compressed inward in order to fit into the mouth. Upon successful insertion into the mouth, each lip grip 12 expands outward and each arcuate race 13 presses against the leftward-most and rightward-most portions of the mouth respectively, where upper and lower lips join, thus retracting the cheeks away from teeth and gums. The lip grips 12 are each positioned on the end of a spring arm 14 which are joined in the middle at the location of an angled tab 16. In this embodiment, the angled tab includes an approximately 90 degree angle. However, other angles are possible and may be determined by one of ordinary skill in the art according to a desired size/shape combination of the adjustable cheek retractor with saliva extracting tongue guard 10. The spring arms 14 are aptly named as they allow for the compression and expansion of the lip grips 12 during insertion and removal. The angled angle tab 16 of the cheek retractor 11 is an alteration to a standard cheek retractor. The cheek retractor 11 may be provided in at least three widths: small, medium, and large. Also, the material comprising the cheek retractor 11 can be sterilized in an autoclave for safe reuse or can be disposable. For example, the cheek retractor 11 may be made of stainless steel or other heat and pressure resistant material.

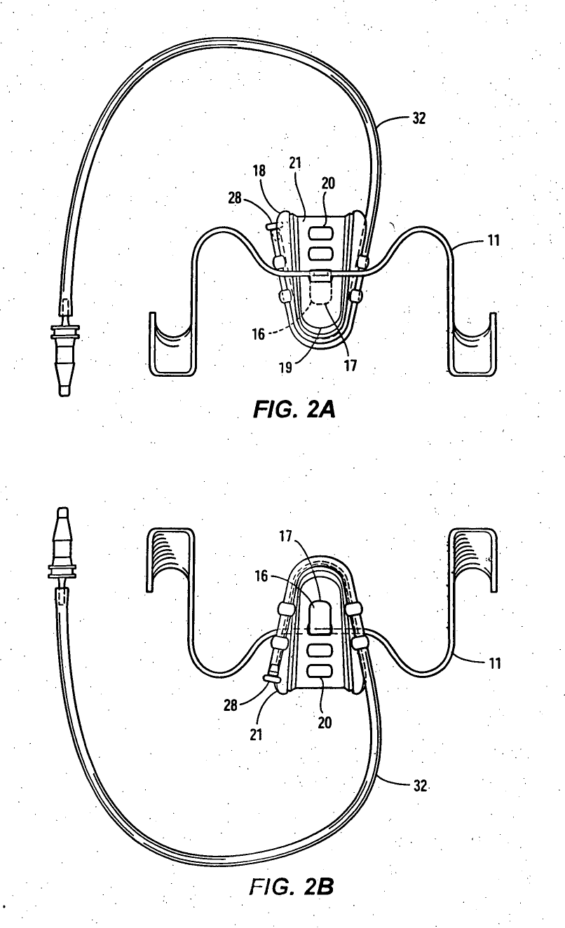

As shown in FIG. 2a and FIG. 2b, the angled tab 16 of the cheek retractor 11 is designed to fit into an elongate aperture 20 on a top surface 21 of the tongue guard 18. The top surface 21 contains a plurality of elongate apertures 20, into one of which the dental professional can insert the angled tab 16, before or during installation of the adjustable cheek retractor with saliva extracting tongue guard 10 into the patient's mouth. The exact position chosen depends on the size and/or shape of the patient's mouth. The cheek retractor 11 is installed so that a lip 17 of the angled tab 16 drops downward through the elongate aperture 20, and faces toward a rounded top forward edge 19 of the tongue guard 18 when the angled tab 16 is locked into an operating position.

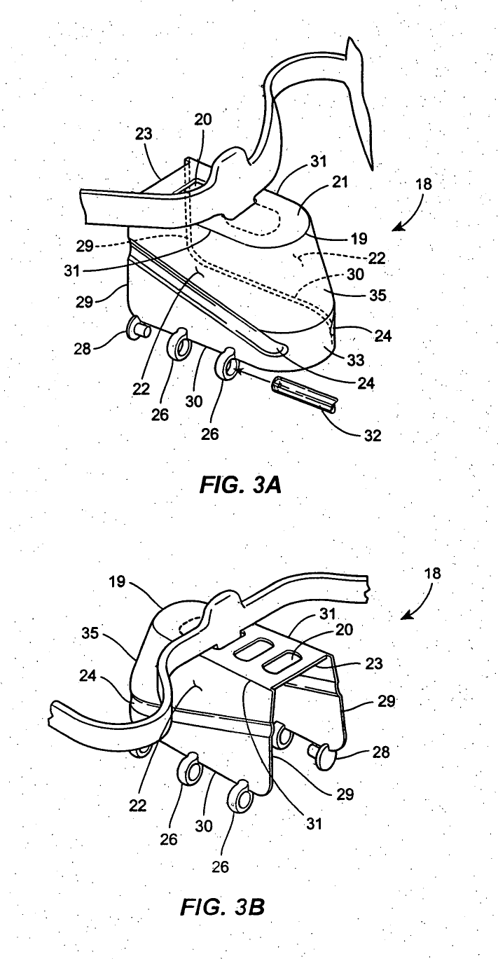

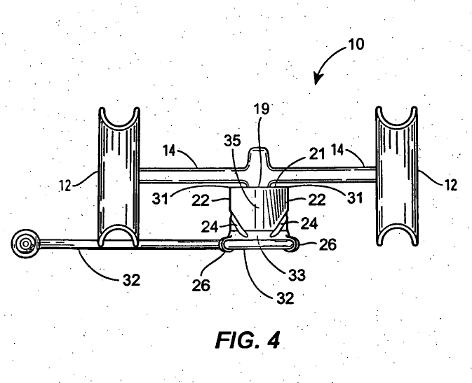

As shown in FIG. 3a and FIG. 3b (Most of the numbered features shown in FIG. 3a and FIG. 3b are also shown in FIG. 4, a front view of this embodiment of the disclosure), the tongue guard 18 includes the top surface 21, containing various elongate apertures 20, with a rear edge 23 that joins a top edge 31 on each side, the top edges 31 wrap around and meet at the top forward edge 19. The tongue guard 18 also includes a rear vertical edge 29 which drops downward from ends of the rear horizontal edge 23, and proceeds to meet with a bottom edge 30, after changing direction through a rounded area 27. Each bottom edge 30 wraps around and meets at a bottom forward edge 34. Since the distance from the rear vertical edge 29 to the bottom forward edge 34 is greater than the distance from the rear vertical edge 29 to the top forward edge 19, a bottom front wall 33 and a top front wall 35 are created as a sidewall 22 wraps from each rear vertical edge 29 toward the front of the tongue guard 18. An angle is formed where the bottom front wall 33 and the top front wall 35 meet. On each sidewall 22, a groove 24 is cut from near a forward part of the bottom edge 30 and this groove travels upward and rearward and ends near the middle of each sidewall 22 close to the rear vertical edge 29. Holders 26 are molded at various positions along the bottom edge 30. Each holder 26 has a round open internal diameter and secures a perforated tubing 32 (commonly used in dentistry for saliva extraction) threaded through each holder 26 along the bottom edge 30, until an end 36 of the perforated tubing 32 reaches a blind stop 28. The end 36 of the perforated tubing 32 is plugged into the blind stop 28, which acts to secure and plug the end 36. The end 36 is plugged so that a vacuum is created within the perforated tubing 32 when a vacuum source is connected to the perforated tubing 32. Saliva that is near any of the perforations in the tubing will be drawn into the perforated tubing 32 and carried away from the mouth of the patient. The tongue guard 18 is made available in at least three sizes to accommodate the size of the patient's tongue. The material comprising the tongue guard. 118 can be sterilized in an autoclave for safe reuse or can be disposable. For example; the tongue guard. 18 may be made of stainless-steel or other heat and pressure resistant material.

1. An adjustable cheek retractor system comprising:
a cheek retractor comprising a pair of lip grips disposed apposite ends of a spring arm, and an angled tab disposed on the spring arm, the lip grips each comprising an arcuate race; and
a tongue guard comprising a top surface, a front wall and a pair of side walls extending from the top surface forming a tub-like casing having a bottom edge and an open back end, the top surface including an aperture, a tube holder and the blind stop disposed along the bottom edge; and
a flexible perforated tube disposed in the tube holder, one end of the flexible perforated tube being disposed adjacent the blind stop,
wherein the angled tab is received in the aperture thereby securing the cheek retractor to the tongue guard.

2. The adjustable cheek retractor system of claim 1 wherein the adjustable cheek retractor is made of an autoclave safe material.

3. The adjustable cheek retractor system of claim 2 wherein the material is stainless steel.

4. The adjustable cheek retractor system of claim 1 wherein the tongue guard is made of an autoclave safe material.

5. The adjustable cheek retractor system of claim 4 wherein the material is stainless steel.

6. The adjustable cheek retractor system of claim 1 wherein the angled tab forms an approximately 90 degree angle.

7. The adjustable cheek retractor system of claim 1 wherein the angled tab faces toward the front wall of the tongue retractor when the angled tab is disposed in the aperture.

8. The adjustable cheek retractor system of claim 1 wherein the top surface includes a plurality of apertures.

9. The adjustable cheek retractor system of claim 1 comprising a plurality of holders disposed along the bottom edge.

10. The adjustable cheek retractor system of claim 1 comprising a groove formed in each sidewall of the tongue guard.

11. The adjustable cheek retractor system of claim 1 wherein the flexible perforated tube is connected to a vacuum source.

12. The adjustable cheek retractor system of claim 1 wherein the front wall of the tongue guard comprises two wall sections joined together at an angle, thereby defining an opening along the bottom edge that is larger than the top surface.

13. The adjustable cheek retractor system of claim 1 wherein the tube holder is circular.

14. The adjustable cheek retractor system of claim 13 comprising a plurality of tube holders spaced along the bottom edge.

15. An adjustable cheek retractor system comprising:
a cheek retractor comprising a pair of lip grips disposed at opposite ends of a spring arm, and an angled tab disposed on the spring arm, the lip grips each comprising an arcuate race; and
a tongue guard comprising a top surface, a front wall and a pair of side walls extending from the top surface forming a tub-like casing having a bottom edge and an open back end, the top surface including a plurality of apertures, a tube holder and the blind stop disposed along the bottom edge; and
a flexible perforated tube disposed in the tube holder, one end of the flexible perforated tube being disposed adjacent the blind stop,
wherein the angled tab is received in one of the plurality of apertures thereby securing the cheek retractor to the tongue guard and wherein the each one of the plurality of apertures defines different sizes of the adjustable cheek retractor system when the angled tab is disposed therein.

16. A method of manufacturing an adjustable cheek retractor system comprising:
providing a cheek retractor having a pair of lip grips disposed at opposite ends of a spring arm;
attaching an angled tab to the spring arm;
providing a tongue guard having a top surface that includes a plurality of apertures;
wherein the angled tab is arranged to cooperate with the plurality of apertures to enable a user to secure the cheek retractor to the tongue guard thereby determining a size of the adjustable cheek retractor system according to the aperture in which the angled tab is disposed, and wherein the tongue guard is adapted to receive a flexible perforated tube.

17. The method of claim 16 comprising:
forming a plurality of tube holders along a bottom edge of the tongue guard.

18. The method of claim 17 wherein at least one of the plurality of tube holders is circular.

19. The method of claim 16 wherein the angled tab includes an approximately 90 degree angle.

20. The method of claim 16 comprising forming a groove in a sidewall of the tongue guard.
